(19) United States
(12) Patent Application Publication
(10) Pub. No.: US 2018/0095526 A1
(43) Pub. Date: Apr. 5, 2018

(54) VIRTUAL REALITY SYSTEM AND METHOD FOR IMPLEMENTING THE SAME

(71) Applicant: BOE TECHNOLOGY GROUP CO., LTD., Beijing (CN)

(72) Inventor: Defeng MAO, Beijing (CN)

(21) Appl. No.: 15/527,432

(22) PCT Filed: Oct. 31, 2016
(86) PCT No.: PCT/CN2016/103965

§ 371 Date: May 17, 2017

(30) Foreign Application Priority Data
Jan. 26, 2016 (CN) 201610052380.2

(51) Int. Cl. G06F 3/01; G06T 19/00; G06F 13/10; A63G 31/16

(52) U.S. Cl. CPC G06F 3/011; G06T 19/003; A63G 31/16; G06F 3/017; G06F 13/10

(57) ABSTRACT

The present disclosure provides a virtual reality (VR) system, including: a display device for displaying a VR scene and being wearable; a manned mobile device for adjusting a position of a viewer according to the VR scene; and an auxiliary device for providing auxiliary functions according to the VR scene.

### CROSS-REFERENCES TO RELATED APPLICATIONS

This PCT patent application claims priority of Chinese Patent Application No. 201610052380.2, filed on Jan. 26, 2016, the entire content of which is incorporated by reference herein.

### TECHNICAL FIELD

The present invention generally relates to the display technologies and, more particularly, relates to a virtual reality (VR) system and a method for implementing the VR system.

### BACKGROUND

A virtual reality (VR) system is a high-tech system that emerges in the fields of graphics and images in the recent years. A VR system often utilizes computer programs to generate a three-dimensional (3D) virtual space to replicate an environment, and simulates the user/viewer's presence in the environment. A VR system simulates sensory experience such as sight, touch, hearing, and smell for the user/viewer interactions. The user may perceive the simulated sensations and feel like being in the environment.

VR systems are often implemented by terminals with display functions, such as smart phones and tablet computers, in VR headsets or VR goggles. Viewers can watch 3D videos, play VR games, see different VR scenes, etc. Further, VR systems with enhanced immersive virtual experience are becoming popular.

### BRIEF SUMMARY

Embodiments of the present disclosure provides a VR system, a method for implementing the VR system, and a related psychotherapy system. Embodiments of the present disclosure provide immersive effect of the VR system with enhanced virtual user experience.

One aspect of the present disclosure provides a virtual reality (VR) system, including: a display device for displaying a VR scene and being wearable; a manned mobile device for adjusting a position of a viewer according to the VR scene; and an auxiliary device for providing auxiliary functions according to the VR scene.

Optionally, the VR system further includes a controller for controlling the display device, the manned mobile device, and the auxiliary device.

Optionally, the display device includes a monitor, a storage, and a controller. The storage stores data of a plurality of VR scenes. The controller controls the monitor to display the VR scenes according to the viewer's commands.

Optionally, the storage stores data of VR scenes related to a viewer's experience; and the display device displays VR scenes based on the data of VR scenes related to the viewer's experience.

Optionally, the auxiliary device includes at least one of a water sprinkling apparatus for sprinkling water, an air blowing apparatus for blowing air, a solid float blowing apparatus for blowing solid floats, and an electric shock apparatus for providing electric shocks.

Optionally, the manned mobile device includes a carrying part and a moving part. The carrying part carries the viewer. The moving part is coupled with the carrying part, the moving part driving the carrying part to adjust the position of the viewer.

Optionally, the VR system further includes a VR-scene sampling device for sampling VR scenes displayed by the display device.

Optionally, the VR system further includes a shell, wherein the manned mobile device and the auxiliary device are arranged in the shell.

Optionally, the VR system further includes a feedback mechanism for capturing a user's movements in response to displayed images and send signals reflecting the user's movements to the controller.

Optionally, adjusting the position of the viewer includes moving forward, moving backward, rotating, moving upward, moving downward, swinging, and inclining.

Optionally, the VR scene sampling device is a camera.

Optionally, the moving part includes a first sub-moving part and a second sub-moving part. The first sub-moving part drives the carrying part to move upward, move downward, and rotate. The second sub-moving part is vertically fixed onto the first sub-moving part to control the first sub-moving part to incline, swing, and move, such that the first sub-moving part drives the carrying part to incline, swing, and move.

Optionally, the first sub-moving part includes at least two first supporting pillars and the second sub-moving part comprising at least two supporting pillars. The two first supporting pillars are nested together, except for a first supporting pillar being farthest from the carrying part, other first supporting pillars being able to rotate with respect to the first supporting pillar being farthest from the carrying part. The two second supporting pillars are nested together.

Another aspect of the present disclosure provides a method for implementing a disclosed VR system, including: obtaining control information corresponding to a VR scene being displayed by the display device, the control information including information for adjusting a position of the manned mobile device and controlling the auxiliary device to provide auxiliary functions; and based on the control information, controlling the manned mobile device to adjusts the position and controlling the auxiliary device to implement auxiliary functions.

Optionally, the storage includes data of a plurality of stored VR scenes and a plural pieces of control information corresponding to some of the stored VR scenes. Obtaining the control information further includes: determining if the control information exists; if the control information exists, searching the storage of the display device and obtaining the control information; and if the control information does not exist, sampling the VR scene being displayed by the display device, comparing a sampled VR scene with the stored VR scenes, determining a stored VR scene with a highest similarity level to the VR scene being displayed by the display device, and obtaining control information corresponding to the stored VR scene with the highest similarity level.

Optionally, the method further includes: if a stored VR scene with the highest similarity level does not exist, displaying a VR scene according to a viewer's demand or starting to preprogram the control information corresponding to the VR scene being displayed.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates connections of different devices in an exemplary VR system according to various disclosed embodiments of the present disclosure;

FIG. 2 illustrates a block diagram of an exemplary display device used in a VR system according to various disclosed embodiments of the present disclosure;

FIG. 3 illustrates an exemplary manned mobile device according to various disclosed embodiments of the present disclosure;

FIG. 4 illustrates an exemplary VR system according to various disclosed embodiments of the present disclosure;

FIG. 5 illustrates an exemplary process to implement a VR system according to various disclosed embodiments of the present disclosure; and

FIG. 6 illustrates an exemplary flow chart of a method to implement a VR system according to various disclosed embodiments of the present disclosure.

### DETAILED DESCRIPTION

For those skilled in the art to better understand the technical solution of the invention, reference will now be made in detail to exemplary embodiments of the invention, which are illustrated in the accompanying drawings. Wherever possible, the same reference numbers will be used throughout the drawings to refer to the same or like parts.

Embodiments of the present disclosure provide a VR system with a display device, a shell, a manned mobile device, and an auxiliary device. A controller of the display device may obtain control information corresponding to a VR scene being displayed by the display device. The control information may include proper data/information such as information for adjusting the position of the manned mobile device and controlling the auxiliary device to provide auxiliary functions.

Based on the control information, the controller may control the manned mobile device to adjust positions and control the auxiliary device to implement auxiliary functions, such as sprinkling water or blowing air. Embodiments of the present disclosure thus provide an immersive user experience of the VR.

One aspect of the present disclosure provides a VR system.

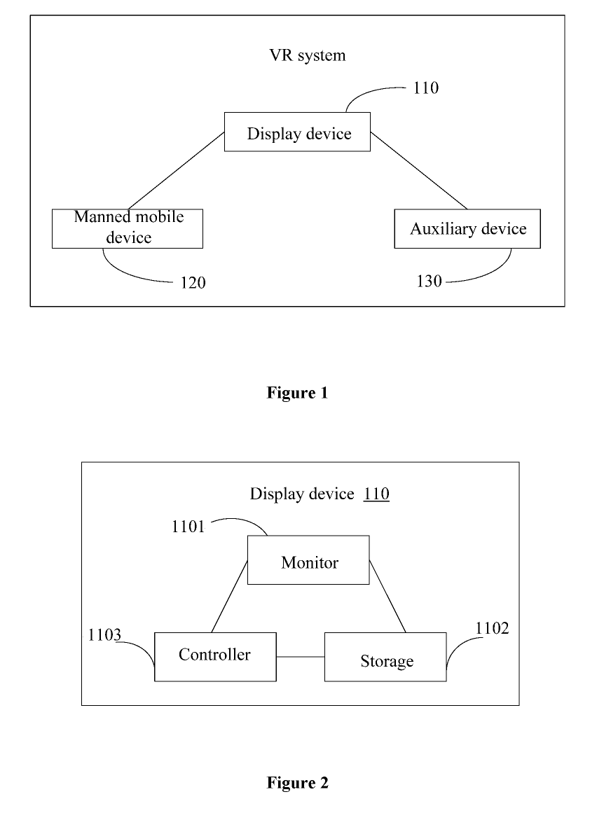

FIG. 1 illustrates an exemplary block diagram of the VR system. As shown in FIG. 1, the VR system may include a display device 110, a manned mobile device 120, and an auxiliary device 130.

The display device 110 may display VR scenes. The manned mobile device 120 may simultaneously adjust the viewer's position in accordance with the VR scene displayed by the display device 110. The auxiliary device 130 may simultaneously implement auxiliary functions in accordance with the VR scene to enhance or improve the user's experience of presence in the VR scene.

In this example, the VR scenes provided by the display device 110 is sufficient to immerse the viewer in the artificial environment.

Further, the manned mobile device 120 is configured to carry the user and ensure the safety of the user when simultaneously adjusting its positions in accordance with the VR scenes displayed by the display device 110. When the manned mobile device 120 is carrying a user, it is desired that the user can see the VR scenes displayed by the display device 110.

In some embodiments, the adjusting of the position of the manned mobile device 120 may include various movements such as moving forward, moving backward, moving upward, moving downward, inclining, rotating, and swinging.

For example, if the VR scene, display by the display device 110, is a car racing game, the manned mobile device 120 may simultaneously incline to the left front direction when the virtual racing car is turning to the left. If the VR scene, displayed by the display device 110, is rapidly crossing a waterfall, the manned mobile device 120 may simultaneously incline towards the front.

Further, the auxiliary device 130 may provide auxiliary functions such as sprinkling water, blowing air, blowing solid floats, sending electric shock, etc. The auxiliary functions would not impair the safety of the viewer. The auxiliary functions may be applied on the entire body of the user, or may be applied on one or more sensing body parts such as hands, feet, and neck, of the user.

For example, if the VR scene displayed by the display device 110, is a car racing game, when the racing car is turning left, the manned mobile device 120 may simultaneously incline towards the left front direction. At this time, the auxiliary device 130 may blow air towards a direction that is opposite of the moving direction of the manned mobile device 120.

If the VR scene displayed by the display device 110, is rapidly crossing a waterfall, the manned mobile device 120 may simultaneously be inclined towards the front direction. At this time, the auxiliary device 130 may simultaneously sprinkle water to the viewer and blow air towards a direction that is opposite of the moving direction of the manned mobile device 120. If the VR scene displayed by the display device 110, is snowing, the auxiliary device 130 may blow solid floats with white color, e.g., scraps of white paper or shredded cotton, to replicate a snowing scene for the viewer.

Further, the display device 110, the manned mobile device 120, and the auxiliary device 130 may be connected through wired or wireless connections. The display device 110, the manned mobile device 120, and the auxiliary device 130 may be connected directly or indirectly.

The manned mobile device 120 and the auxiliary device 130 may be operated together or separately.

In the disclosed VR system, the display device 110 may display VR scenes, and the manned mobile device 120 and the auxiliary device 130 may be configured to accommodate the VR scenes and implement corresponding movements and/or auxiliary functions. The immersive effect of the VR system may be greatly improved, and the viewer may experience an enhanced sense of presence.

In some embodiments, as shown in FIG. 2, the display device 110 may include a monitor 1101, a storage 1102, and a controller 1103. The storage 1102 may be configured to store the data of a plurality of VR scenes. The viewer may use the controller 103 to control the monitor 1101 for displaying a selected VR scene.

Each one of the controller 1103, the monitor 1101, and the storage 1102 may be connected with the other two. When the viewer selects a desired VR scene from the plurality of VR scenes stored in the storage 1102, the viewer may use the controller 1103 to control the display device 1101 to display the selected VR scene.

In some embodiments, the display device 110 may be a wearable device. For example, the display device 110 may be a VR headset or a pair of VR goggles.

For example, the display device 110 may be a pair of VR goggles. Accordingly, the working principles of VR goggles may be described as follows.

In some embodiments, the VR system may project the selected VR scenes on a prism such that the viewer may see the images displayed on the prism. Optionally, a pair of google glasses may be used as the display device 110.

In some embodiments, a camera may be configured to capture various data and information. A high-performance central processing unit (CPU) and a graphic processing unit (GPU) may process the captured data and information. A holographic processing unit (HPU) may create a virtual object through stacking colored lenses. Optionally, a HoloLens may be used as the display device 110.

In some embodiments, a micro projector and a translucent prism may be used to project images of the selected VR scenes onto the viewer's retina. Optionally, a pair of smart glasses, e.g., MOVERIO BT-200 by Epson, may be used as the display device 110.

It should be noted that, VR headsets may also be configured to display VR scenes using the described working principles. Details related to displaying VR scenes are not repeated herein.

In some embodiments, the viewer may wear the display device 110 such that the distance between the VR scenes, displayed by the display device 110, may be sufficiently close to the viewer's eyes. At least a great portion of what the viewer sees would be the VR scenes displayed by the display device. Accordingly, it may be easier for the viewer to be immersed in the VR scenes.

In some embodiments, the auxiliary device 130 may include at least one of a water sprinkling apparatus, an air blowing apparatus, a solid float blowing apparatus, an electric shock apparatus, and so on. Different apparatus may be operated separately or may be integrated to perform desired functions, depending on the applications.

It should be noted that, the auxiliary device 130 may also include other suitable devices or structures with auxiliary functions. The auxiliary device 130 can provide auxiliary functions with sufficient safety for the viewer.

In some embodiments, the water sprinkling apparatus and the air blowing apparatus may be integrated together. That is, the integrated apparatus may be used to sprinkle water and blow air at different times or simultaneously. In certain other embodiments, the water sprinkling apparatus and the air blowing apparatus may be two independent apparatus, which can be operated separately and independently.

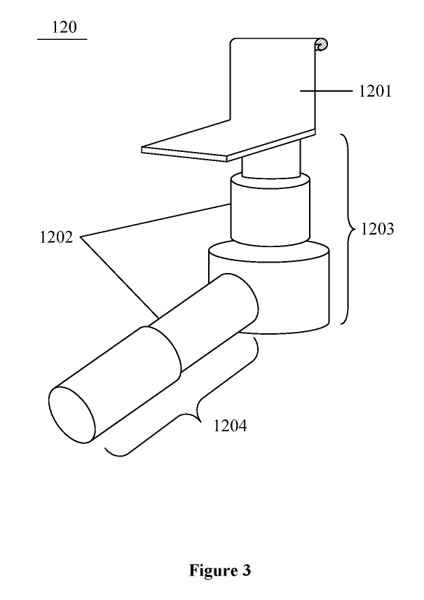

In some embodiments, as shown in FIG. 3, the manned mobile device 120 may include a carrying part 1201 and a moving part 1202. The carrying part 1201 may be configured to carry the user/viewer.

The moving part 1202 may be coupled with the carrying part 1201 through a suitable means and may be fixed onto the carrying part 1201. The moving part 1202 may be located at a suitable position with respect to the carrying part 1201, e.g., being under or above the carrying part 1201. The moving part 1202 may drive the carrying part 1201 to adjust the viewer's positions. The adjusting of positions may include rotating, moving upward, inclining, swinging, moving toward, moving backward, and so on. The specific movements of the moving part 1202 may be designed in response to the VR scenes displayed by the display device 110 and should not be limited by the embodiments of the present disclosure.

The carrying part 1201 may be a chair, a bed, or any suitable part or structure that can be used to carry the viewer. For illustrative purposes, the carrying part 1201 shown in FIG. 3 is a chair.

The specific structure of the moving part 1202 may be determined or adjusted according to different VR scenes. For example, the structure of the moving part 1202 may enable the moving part 1202 to rotate, move upward, move downward, incline, swing, move forward, move backward, etc. The specific structure of the moving part 1202 should not be limited by the embodiments of the present disclosure.

Because the moving part 1202 is fixed onto the carrying part 1201, the moving part 1202 may drive the carrying part 1201 to move according to the movement of the moving part 1202. For example, when the moving part 1202 is rotating, moving upward, moving downward, swinging, moving forward, and moving backward, the carrying part 1201 may be driven to also rotate, move upward, move downward, swing, move forward, and move backward accordingly. In some embodiments, when the moving part 1202 moves up, the carrying part 1201 may move upward. In some other embodiments, when the moving part 1202 moves forward, the carrying part 1201 may move upward. The specific correspondence between the movement of the moving part 1202 and the carrying part 1201 should be determined according to different applications and should not be limited by the embodiments of the present disclosure.

Further, in some embodiments, as shown in FIG. 3, the moving part 1202 may include a first sub-moving part 1203 and a second sub-moving part 1204.

The first sub-moving part 1203 may drive the carrying part 1201 to move, e.g., move upward, move downward, and rotate. The second sub-moving part 1204 may be vertically fixed onto the first sub-moving part 1203 to control the movement of the first sub-moving part 1203, e.g., moving upward, moving downward, and rotating. Thus, the first sub-moving part 1203 may drive the carrying part 1201 to move accordingly, e.g., move upward, move downward, and rotate.

The first sub-moving part 1203 may be configured to move in certain ways, e.g., move upward, move downward, and rotate. Because the first sub-moving part 1203 is fixed onto the carrying part 1201, when the first sub-moving part 1203 is moving in a certain way, the carrying part 1201 may also be driven to move accordingly. For example, when the first sub-moving part 1203 is moving upward, moving downward, or rotating, the carrying part 1201 may also be driven to move upward, move downward, or rotate.

In some embodiments, because the second sub-moving part 1204 is fixed onto the first sub-moving part 1203, and the first sub-moving part 1203 is fixed onto the carrying part 1201, when the second sub-moving part 1204 rotates, the first sub-moving part 1203 may swing. The first sub-moving part 1203 may drive the carrying part 1201 to swing.

In some embodiments, when the second sub-moving part 1204 is pressed down or lifted up, the first sub-moving part 1203 may be inclined. The first sub-moving part 1203 may drive the carrying part 1201 to incline. The direction to press down or lift up the second sub-moving part 1204 may be controlled so that the carrying part 1201 may incline toward any desired direction. In some embodiments, when the second sub-moving part 1204 is moving in a certain direction, the first sub-moving part 1203 may be driven to move in a certain direction. The first sub-moving part 1203 may drive the carrying part 1201 to move in a certain direction.

Further, in some embodiments, the first sub-moving part 1203 may include at least two first supporting pillars. The at least two first supporting pillars may be nested and/or stacked together. Except for the first supporting pillar that is farthest away from the carrying part 1201, the other first supporting pillars may rotate with respect to the first supporting pillar that is farthest away from the carrying part 1201.

The second sub-moving part 1204 may include at least two second supporting pillars. The at least two second supporting pillars may be nested and/or stacked together.

It should be noted that, the terms “first” and “second” are used merely to distinguish the supporting pillars used in the first sub-moving part 1203 and the second sub-moving part 1204, and do not indicate any differences in functions or structures of the supporting pillars.

In some embodiments, the first sub-moving part 1203 and the second sub-moving part 1204 may each include two or more supporting pillars. The specific number of supporting pillars used in the first sub-moving part 1203 and the second sub-moving part 1204, and the length of each supporting pillar may be determined according to the desired positions and moving range of the carrying part 1201, and should not be limited by the embodiments of the present disclosure.

It should be noted that, the nested supporting pillars used in the first sub-moving part 1203 and the second sub-moving part 1204 may be coaxially arranged. The nested supporting pillars, as a whole, may be configured to extend or retract. For example, when the nest first supporting pillars in the first sub-moving part 1203 extend, the carrying part 1201 may move upward. When the nested first supporting pillars in the first sub-moving part 203 retract, the carrying part 1201 may move downward. Similarly, when the nested second supporting pillars in the second sub-moving part 1204 extend, the carrying part 1201 may move forward. When the second supporting pillars in the second sub-moving part 1204 retracts, the carrying part 1201 may move backward.

Further, the manned mobile device 120 may further include a driving part and a control part for controlling the driving part. The manned mobile device 120 may further include devices and structures for performing desired movements such as rotating, moving upward, moving downward, inclining, swinging, moving forward, and moving backward. For example, the devices and structure for performing desired movements may include putters, shafts, etc. For example, when the VR scene displayed by the display device 110, shows the viewer's virtual movement is moving upward, the manned mobile device 120 may need to move upward. The control part may control the driving part, e.g., a motor or a cylinder, to move the electric putter in the first sub-moving part 1203 upward such that the first supporting pillars may extend. The first supporting pillars may drive the carrying part 1201 to move upward. Thus, the viewer may be moved upward.

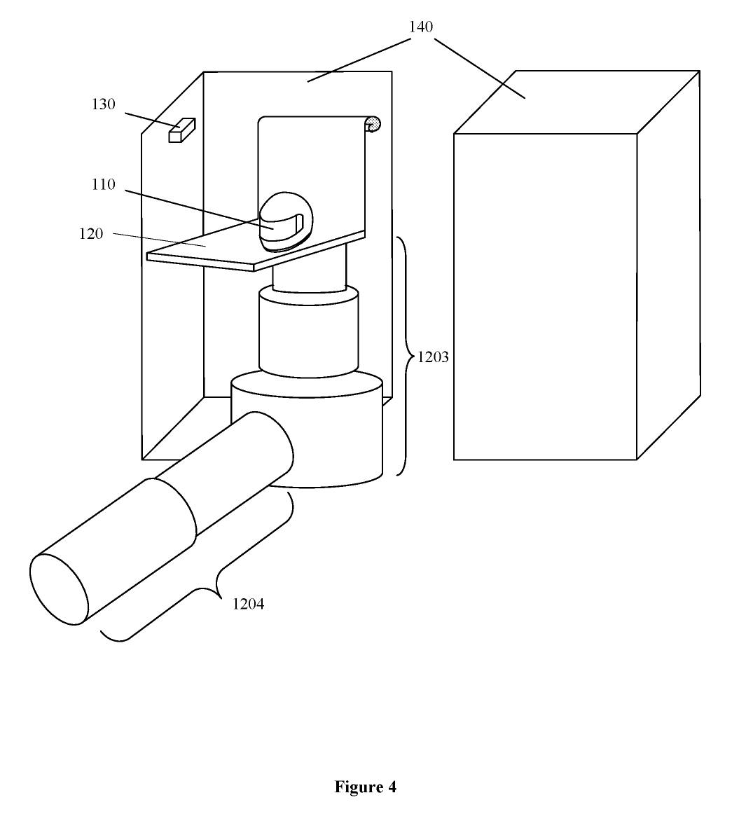

In some embodiments, as shown in FIG. 4, the VR system may further include a shell 140. The manned mobile device 120 and the auxiliary device 130 may be arranged in the shell 140.

In some embodiments, if the display device 110 is not wearable, the display device 110 may also be arranged in the shell 140. If the display device 110 is wearable, the display device 110 may perform corresponding functions when the viewer wears the display device 110.

The auxiliary device 130 may be positioned at any position in the shell 140. For example, the auxiliary device 130 may be positioned at the top, at the bottom, or on a sidewall of the shell 140.

It should be noted that, the manned mobile device 120 and the auxiliary device 130 may or may not be fully positioned in the shell 140. When the viewer is sitting on the manned mobile device 120, the VR system may simultaneously adjust the position of the viewer and provide proper auxiliary functions.

Further, the dimensions of the shell 140 may be adjusted according to the moving range of the manned mobile device 120. The moving part 1202 may be fully or partially arranged in the shell 140. The moving part 1202 may also be arranged outside the shell 140. The specific arrangement of the moving part 1202 should be according to different applications of the VR system and should not be limited by the disclosed embodiments of the present disclosure.

In some embodiments, the manned mobile device 120 and the auxiliary device 130 may be arranged in the shell 140. By arranging the manned mobile device 120 and the auxiliary device 130 in the shell 140, the auxiliary device 130 may be arranged in any desired positions in the shell 140. The auxiliary device 130 may provide auxiliary functions at different positions and from different directions of the shell 140 such as from the side, from top to bottom, from bottom to top, etc. In addition, the shell 140 may create a closed environment. The viewer may be free of outside disturbance when using the VR system for entertainment and/or therapy purposes.

Further, accelerated pace of modern life has imposed increased pressure on people. As a result, the number of people suffering from mental illness has significantly increased. Treatments for mental illness often include psychological counseling and antidepressant anxiety medications.

Often, psychological issues are caused by accumulation of certain adverse events or unpleasant experiences. Thus, the present disclosure provides a psychotherapy system, which includes the disclosed VR system. The display device 110 of the VR system may be configured to display VR scenes related to the viewer's experiences.

The VR scenes, displayed by the display device 110 and related to the viewer's experiences, may be recorded in advance of the treatment and stored in the display device 110, as shown in FIG. 2. The VR scenes may also be animated or simulated scenes that replicate the viewer's experiences.

The present disclosure thus provides a psychotherapy system. The psychotherapy system may include the disclosed VR system, which including moving and auxiliary functions, to provide psychotherapy. The user experience of the treatment scenes can be significantly improved and better treatment can be provided to the patient/viewer. Auxiliary functions, such as sprinkling water, blowing air, and electric shock, and/or the adjusting the position of the manned mobile device 120, may be controlled by the psychological counselor, according to the patient's conditions. Thus, better or improved treatment may be provided.

The disclosed VR system may also be used in various other applications such as in entertainment and education settings. The specific applications of the disclosed VR system should not be limited by the disclosed embodiments of the present disclosure.

Another aspect of the present disclosure provides a method for implementing the disclosed VR system.

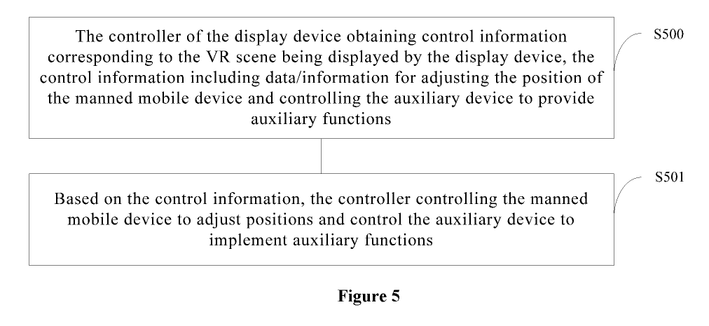

FIG. 5 illustrates an exemplary process flow of the method for implementing the disclosed VR system. FIGS. 1-4 illustrate the structure of the VR system.

In step S500, the controller 1103 of the display device 110 may obtain control information corresponding to the VR scene being displayed by the display device 110. The control information may include proper data/information such as information for adjusting the position of the manned mobile device 120 and controlling the auxiliary device 130 to provide auxiliary functions.

The control information corresponding to the VR scene being displayed by the display device 110 may be programmed in advance and stored in the storage 1102 of the display device 110.

Obtaining the control information corresponding to the VR scene may include the following steps.

First, the controller 1103 may determine if the control information corresponding to the VR scene being displayed by the display device 110 exists. If the control information exists, the controller 1103 may inquire to search in the storage 1102 of the display device 110 and obtain the desired control information. The storage 1102 may be configured to store a plurality of VR scenes and a plural pieces of control information corresponding to at least some of the VR scenes. If the control information does not exist, the controller 1103 may sample the VR scene being displayed by the display device 110, and compare the sampled VR scene with VR scenes stored in the storage 1102. The controller 1103 may further determine a stored VR scene that has the highest similarity level to the VR scene being displayed. The controller 1103 may obtain the control information corresponding to the stored VR scene with the highest similarity level.

After the controller 103 compares the VR scene being displayed to the stored VR scenes, if the control information corresponding to the VR scene that is being displayed by the display device 110 does not exist, and the controller 1103 is not able to find a stored VR scene sufficiently similar to the VR scene being displayed, the controller 1103 may control the display device 110 to display a VR scene selected by the viewer, or start preprogramming the control information, e.g., information for adjusting the position of the manned mobile device 120 and controlling auxiliary functions, corresponding to current VR scene being displayed, according to the viewer's demand.

For example, the viewer may make desired selections so that the controller 1103 may control the display device 110 to keep displaying the current VR scene. Meanwhile, the controller 1103 may start preprogram the control information corresponding to the current VR scene and store the control information in the storage 1102. The controller 1103 may apply the control information to control the manned mobile device 120 and the auxiliary device 130 for the current VR scene, e.g., in real-time operation, or may store the control information in the storage 1102 for future use.

In step S501, based on the control information, the controller 1103 may control the manned mobile device 120 to adjust positions and control the auxiliary device 130 to implement auxiliary functions.

It should be noted that, the display device 110, the manned mobile device 120, and the auxiliary device 130 may be controlled through the controller 1103. The control part for controlling the manned mobile device 120 may or may not be integrated into the controller 1103. When the display device 110 is wearable, to ensure free movements or gestures of the viewer, the controller 1103 may control the display device 110 through wireless communication channels. In one embodiment, the controller 1103 may be integrated in the display device 110. In some other embodiments, the controller 1103 may be an external control device. In certain embodiments, the controller 1103 may be distributed in the display device 110 and outside of the display device 110. The specific form, structure, or arrangement of the controller 1103 should be determined according to different applications and should not be limited by the disclosed embodiments of the present disclosure.

The controller 1103 used in the embodiments of the present disclosure may also be configured to control the operation and functions of different devices in the VR system. A controller 1103 may include a processor, a storage medium, a display, a communication module, a database and peripherals. Certain devices may be omitted and other devices may be included.

Processor may include any appropriate processor or processors. Further, processor can include multiple cores for multi-thread or parallel processing. Processor may execute sequences of computer program instructions to perform various processes. Storage medium may include memory modules, such as ROM, RAM, flash memory modules, and mass storages, such as CD-ROM and hard disk, etc. The storage 1102 and the storage medium may be separate or may be integrated together.

Storage medium may store computer programs for implementing various processes when the computer programs are executed by processor, such as computer programs for rendering graphics for a user interface, implementing a face recognition process, etc. Storage medium may store computer instructions that, when executed by the processor, cause the processor to generate images for 3D displays. The computer instructions can be organized into modules to implement various calculations and functions as described into the present disclosure.

Further, communication module may include certain network interface devices for establishing connections through communication networks. Database may include one or more databases for storing certain data and for performing certain operations on the stored data, such as database searching. Further, the database may store images, videos, personalized information about the user, such as preference settings, favorite programs, user profile, etc., and other appropriate contents.

Display may provide information to a user or users. Display may include any appropriate type of computer display device or electronic device display such as CRT or LCD based devices. Display may also implement 3D display technologies for creating stereoscopic display effects of input contents. Peripherals may include various sensors and other I/O devices, such as body sensor, motion sensor, microphones, cameras, etc.

In an exemplary embodiment, the controller 1103 may control the communication between the user/viewer and other devices in the VR system. The user/viewer may communicate with the VR system to select desired VR scenes to display. The controller 1103 may control the monitor 1101 to display desired VR scenes for the user/viewer. Meanwhile, the controller 1103 may also capture the VR scenes being displayed by the display device and search for suitable control information stored in the display device 110. The controller 1103 may obtain the control information corresponding to the VR scenes being displayed. With the obtain control information, the controller 1103 may control a manned mobile device of the VR system, carrying the viewer/user, to make proper movements or position adjustments, such as moving forward and moving upward, according to the scenes being displayed. Meanwhile, the controller 1103 may also control an auxiliary device of the VR system to provide auxiliary functions, such as sprinkling water and blowing air, to accommodate the VR scenes being displayed.

In some applications, different parts of the controller 1103, e.g., storage medium and processor, may be separate from the hardware used for operating the display device. In some other applications, different parts of the controller 1103 may be integrated with the functions of the display device 110 such that the controller 1103 may be configured to perform functions of the display device 110.

In the present disclosure, the display device 110 may be used to display VR scenes. Control information corresponding to the VR scenes that are displayed by the display device 110 may be obtained by the controller 1103 to control the manned mobile device 120 and the auxiliary device 130 such that the manned mobile device 120 and the auxiliary device 130 may provide functions to accommodate the VR scenes. The manned mobile device 120 may be controlled to perform a certain movement and the auxiliary device 130 may be controlled to provide auxiliary functions. Immersive effects of the VR system may be greatly improved. The viewer may experience an enhance sense of presence in the VR.

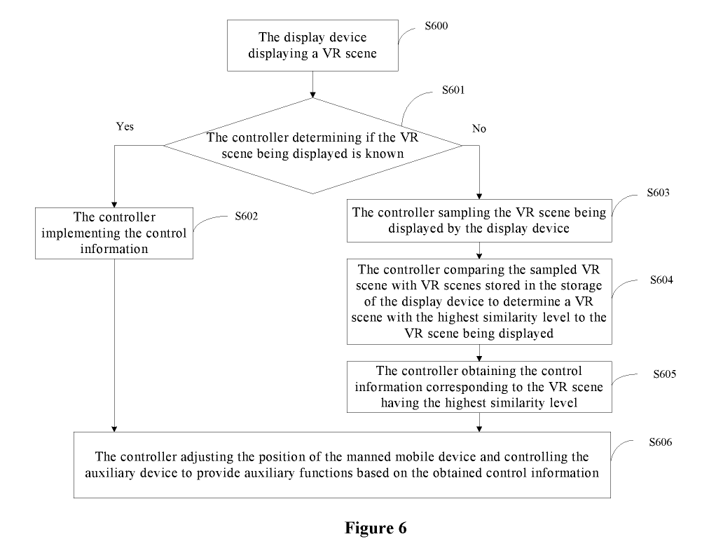

FIG. 6 illustrates an exemplary flow chart of the method. The method may include steps S600-S606.

In step S600, at the beginning of the process, the display device 110 may display a VR scene.

In some embodiments, the VR scene being displayed by the display device 110 may be selected by the viewer.

In step S601, the controller 1103 may determine if the VR scene being displayed is known. If the VR scene being displayed is known, the process may proceed to step S602. If the VR scene being displayed is unknown, the process may proceed to steps S603-S605.

In some embodiments, the controller 1103 may inquire the storage 1102 of the display device 110 to search for the control information corresponding to the VR scene being displayed. If the control information can be located, the VR scene being displayed is known, otherwise the VR scene being displayed is unknown.

In step S602, the controller 1103 may implement the control information.

The control information may include proper data or commands for adjusting the position of the manned mobile device 120 and controlling the auxiliary device 130 to provide auxiliary functions according to the VR scenes being displayed.

In step S603, the controller 1103 may sample the VR scene being displayed by the display device 110.

In some embodiments, an VR-scene sampling device may be used to sample the VR scene displayed by the display device 110. The VR-scene sampling device may be arranged at any suitable position that allows the VR-scene sampling device to sample the VR scene displayed by the display device 110. For example, the VR-scene sampling device may be integrated in the display device 110. The VR-scene sampling device may be a camera or other suitable devices capable of recording VR scenes.

In step S604, the controller 1103 may compare the sampled VR scene with VR scenes stored in the storage 1102 of the display device 110 to determine a VR scene with the highest similarity level to the VR scene being displayed. For example, a sampled VR scene may have a certain similarity level, e.g., 85%, compared to the VR scenes stored in the storage 1102. By sampling a number of VR scenes in a predetermined time period, the controller 1103 may select a VR scene having the highest similarity level among the sampled VR scenes. The number of sampled VR scenes for comparison may be a predetermined number, e.g., 100 VR scenes captured in 0.1 seconds. The number of VR scenes and the predetermined time period may be, e.g., stored in the storage 1102.

In step S605, the controller 1103 may obtain the control information corresponding to the VR scene having the highest similarity level.

The processes to sample the VR scene being displayed by the display device 110, to compare the sampled VR scene to the VR scenes stored in the storage 1102, and to obtain the control information corresponding to the VR scene having the highest similarity level can be completed in microseconds. The physiological limit of human reaction time is about 0.1 seconds. Thus, using existing computer technology and graphic processing technology to sample, compare, and obtain data would not cause delay in viewer's perception.

As described previously, when the control information corresponding to the stored VR scene with the highest similarity level is not stored in the display device 110, the controller 1103 may start preprogramming the control information and use the preprogrammed control information to control the manned mobile device 120 and the auxiliary device 130. The time for preprogramming the control information should be sufficiently short that the viewer would not be able to sense any delay.

It should be noted that, for those skilled in the art, the controller 1103 may determine if two VR scenes are sufficiently similar based on elements such as predetermined conditions, parameters, factors, and/or labels. The specific conditions, parameters, factors, and labels. The specific ways to arrange, access, compare, and determine should be subjected according to different applications and/or designs and should not be limited by the embodiments of the present disclosure.

In step S606, the controller 1103 may adjust the position of the manned mobile device 120 and control the auxiliary device 130 to provide auxiliary functions based on the obtained control information.

When the display device 110 displays VR scenes, based on the obtained control information, the controller 1103 may control the manned mobile device 120 to perform certain movements such as rotating, moving up, moving down, inclining, swinging, moving forward, and moving backward at certain VR scenes. The controller 1103 may also control the auxiliary device 130 to provide auxiliary functions such as sprinkling water, blowing air, and/or electric shock. The immersive effect of the VR system may be greatly improved and the viewer may experience an enhanced sense of presence.

In some embodiments, certain feedback mechanism may be included in the VR system. The feedback mechanism may include a plurality of sensors disposed in the VR system. The sensors may be used to capture and sense the user's movements in response to the displayed images and/or the auxiliary functions. The sensors may transmit signals reflecting the user's movements to the controller 1103 so that the controller 1103 may control the display device 110, the manned mobile device 120, and/or the auxiliary device 130 to respond accordingly. For example, if a user moves his/her arm to block sprinkling water, the sensors may capture the movement and send proper signals to the controller 1103. The controller 1103 may control the auxiliary device 130 to reduce the amount water sprinkled on the user. In another example, the user may move his/her hand to block the wind blown by the auxiliary device. The sensor may capture the movement and send proper signals to the controller 1103. The controller 1103 may control the auxiliary device to reduce the wind.

In certain embodiments, the VR system may include more than one display devices 110, or a display device 110 may include more than one monitor 1101, such that the VR system may be used by more than one user at the same time. In this case, in some embodiments, the VR system may include more than one manned mobile device 120. More than one user may share one display device 110 or more than one display devices 110. The VR system may also include at least one auxiliary device 130 so that more than one user may experience the auxiliary functions provided by the auxiliary devices 130. In some embodiments, more than one user may use the VR system at the same time, and each user may be positioned on a manned mobile device 120. Each user may correspond to an auxiliary device 130 such that the users may experience auxiliary functions when watching images displayed by the display device 110. The numbers of the display devices 110, the manned mobile devices 120, and the auxiliary devices 130 should be determined according to different applications and should not be limited by the embodiments of the present disclosure.

It should be noted by those skilled in the art that, at least a portion of the steps used in disclosed embodiments to implement the method may be realized by hardware related to computer programs. The computer programs may be stored in a readable computer storage medium. When the computer programs are executed, the computer may execute the steps disclosed in the embodiments. The computer storage medium may include ROMs, RAMs, disks, CDs, and any suitable medium that can be used to store computer programs.

It should be understood that the above embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

1-16. (canceled)

17. A virtual reality (VR) system, comprising:
a display device for displaying a VR scene and being wearable;
a manned mobile device for adjusting a position of a viewer according to the VR scene; and
an auxiliary device for providing auxiliary functions according to the VR scene.

18. The VR system according to claim 17, further comprising a control terminal for controlling the display device, the manned mobile device, and the auxiliary device.

19. The VR system according to claim 17, the display device comprising a monitor, a storage, and a controller, wherein:
the storage stores data of a plurality of VR scenes; and
the controller controls the monitor to display the VR scenes according to the viewer's commands.

20. The VR system according to claim 17, the auxiliary device including at least one of a water sprinkling apparatus for sprinkling water, an air blowing apparatus for blowing air, a solid float blowing apparatus for blowing solid floats, and an electric shock apparatus for providing electric shocks.

21. The VR system according to claim 17, the manned mobile device comprising a carrying part and a moving part, wherein:
the carrying part carries the viewer; and
the moving part is coupled with the carrying part, the moving part driving the carrying part to adjust the position of the viewer.

22. The VR system according to claim 17, further comprising a VR-scene sampling device for sampling VR scenes displayed by the display device.

23. The VR system according to claim 17, further comprising a shell, wherein the manned mobile device and the auxiliary device are arranged in the shell.

24. The VR system according to claim 18, further comprising a feedback mechanism for capturing a user's movements in response to displayed images and send signals reflecting the user's movements to the control terminal.

25. The VR system according to claim 19, wherein the storage stores data of VR scenes related to a viewer's experience; and the display device displays VR scenes based on the data of VR scenes related to the viewer's experience.

26. The VR system according to claim 21, wherein adjusting the position of the viewer comprises moving forward, moving backward, rotating, moving upward, moving downward, swinging, and inclining.

27. The VR system according to claim 22, wherein the VR scene sampling device is a camera.

28. The VR system according to claim 26, the moving part comprising a first sub-moving part and a second sub-moving part, wherein:
the first sub-moving part drives the carrying part to move upward, move downward, and rotate; and
the second sub-moving part is vertically fixed onto the first sub-moving part to control the first sub-moving part to incline, swing, and move, such that the first sub-moving part drives the carrying part to incline, swing, and move.

29. The VR system according to claim 28, the first sub-moving part comprising at least two first supporting pillars and the second sub-moving part comprising at least two supporting pillars, wherein:
the two first supporting pillars are nested together, except for a first supporting pillar being farthest from the carrying part, other first supporting pillars being able to rotate with respect to the first supporting pillar being farthest from the carrying part; and
the two second supporting pillars are nested together.

30. A method for implementing a VR system according to claim 17, comprising:
obtaining control information corresponding to a VR scene being displayed by the display device, the control information including information for adjusting a position of the manned mobile device and controlling the auxiliary device to provide auxiliary functions; and
based on the control information, controlling the manned mobile device to adjusts the position and controlling the auxiliary device to implement auxiliary functions.

31. The method according to claim 30, the storage comprising data of a plurality of stored VR scenes and a plural pieces of control information corresponding to some of the stored VR scenes, wherein obtaining the control information further comprises:
determining if the control information exists;
if the control information exists, searching the storage of the display device and obtaining the control information; and
if the control information does not exist, sampling the VR scene being displayed by the display device, comparing a sampled VR scene with the stored VR scenes, determining a stored VR scene with a highest similarity level to the VR scene being displayed by the display device, and obtaining control information corresponding to the stored VR scene with the highest similarity level.

32. The method according to claim 31, further comprising: if a stored VR scene with the highest similarity level does not exist, displaying a VR scene according to a viewer's demand or starting to preprogram the control information corresponding to the VR scene being displayed.
